(19) United States
(12) Patent Application Publication
(10) Pub. No.: US 2009/0326312 A1
(43) Pub. Date: Dec. 31, 2009

(54) METHOD FOR VITRIFICATION OF FISSION PRODUCTS

(75) Inventors: Roger Boen, Saint Alexandre (FR); Agnes Grandjean, Saint Marcel De Careiret (FR); Olivier Pinet, Poulx (FR); Bruno Penelon, St Just D'Ardeche (FR)

Correspondence Address: PEARNE & GORDON LLP, 1801 EAST 9TH STREET, SUITE 1200, CLEVELAND, OH, 44114-3108, US

(73) Assignee: COMMISSARIAT A L'ENERGIE ATOMIQUE, Paris (FR)

(21) Appl. No.: 12/443,834

(22) PCT Filed: Oct. 4, 2007
(86) PCT No.: PCT/EP07/60529

§ 371 Date: Apr. 1, 2009

(30) Foreign Application Priority Data
Oct. 5, 2006 (FR) 06 54110

(51) Int. Cl. G21F 9/16

(52) U.S. Cl. 588/12; 588/11

(57) ABSTRACT

The mass to be vitrified undergoes a reduction operation in order to have the ruthenium pass from an oxidized state to a metal state in order to reduce the viscosity, the electric conductivity and to obtain good chemical kinetics.

The invention relates to a method for vitrification of fission products, stemming from methods for reprocessing irradiated fuels.

The fission products are confined in generally borosilicate vitreous matrices. In one method, the solution of the molten products is calcinated, and then mixed with a glass sinter and the mixture is melted in order to elaborate the final glass. In another method, the result of which is identical, calcination of the solution of the fission products occurs at the surface of the glass melted beforehand, and the final glass is elaborated by achieving simultaneous melting of the calcinate and of additives which may comprise glass sinter, chemical precursors of glass, oxides, nitrates, carbonates or other additives.

As the starting products contain nitrates, the glass is traditionally elaborated in an oxidizing medium, which leads to a pressure of dissolved oxygen larger than or equal to 0.1 bar in practice.

The inventors have noticed that certain defects of these methods as they are applied, stemmed from the presence of ruthenium in the fission products.

In the known methods, ruthenium does not dissolve in glass but is retained therein in the form of crystals of dioxide RuO₂, which are polyhedral or in the form of needles and insoluble in liquid glass. Even with a low concentration, these crystals clearly modify the properties of liquid glass. They increase its viscosity (which passes for example for R7T7 glass, the composition of which is given in Table 1, from 90 dpa.s to 125 dpa.s at 1,100° C., when the ruthenium oxide is at a concentration of 2%), which reduces the casting rate and the efficiency of the system for stirring liquid glass. They increase the electric conductivity of glass by adding thereto a conductivity of electronic nature rather than ionic nature (for the same glass, resistivity passes from 10 Ohm.cm to 2 Ohm.cm for the same concentration of 2% of ruthenium oxide), which reduces the power of the Joule effect heating systems and transforms the heterogeneities of the ruthenium distribution into heating heterogeneities. Finally, they decrease the kinetics of chemical reactions for dissolving the calcinate in the molten glass, which requires an increase in the dwelling time of the glass being elaborated in the oven.

This drawback should subsist in the methods of documents GB-A-2,217,098, GB-A-2,025,686 and FR-A-2 374 728, although it is specified therein that reduction of ruthenium is undertaken : the object of these prior patents is to avoid the formation of volatile ruthenium, i.e. ruthenium tetroxide RuO₄ which actually has this property; now they resort to reducing agents such as sugar, formic acid, formalin, starch and urea, which are too mild for reducing beyond ruthenium dioxide RuO₂, to such an extent that the difficulty stated above remains entire. These methods should provide pressures of dissolved oxygen between 0.1 bar and 1 bar, which one would want to avoid.

An improvement of the methods for vitrification of fission products is proposed here, according to which the glass is elaborated in a chemically reduced form so as to give rise to reduction of ruthenium oxides (RuO₂) towards metal ruthenium (Ru), during said elaboration. Ruthenium is solid and insoluble in liquid glass in its metal form, but it does not change very much the viscosity, electric conductivity and reactivity properties thereof in the kinetics of dissolution of the calcinate of the fission products.

The oxidation state of ruthenium is set by the oxidation state of glass. The glasses used are very oxidizing because of the presence of nitrates in the fission products which are incorporated to the glass either by mixing with glass sinter or as a solution.

Four techniques are mainly proposed here for making the glass less oxidizing. In the first, which may be used in the first kind of methods, a reducing glass sinter is used, i.e. including oxides of metal elements at several oxidation levels which are placed at their lower oxidation level (such as Fe2, Ce3, Cr3, V3, Ti3, S-2, Sb3, or As3) between the metal state and a higher oxidation step. Ruthenium oxide is then reduced according to a reaction such as RuO₂+4 FeO→Ru+2 Fe₂O₃ or RuO₂+2 Ce₂O₃→Ru+4 CeO₂. The mixtures comprising several of these incompletely oxidized elements may also be used.

A second technique consists of using glass precursors comprising reducing elements of the same kind as the previous ones, and which may be added in the second method as a solid, in a solution or in a suspension. Ruthenium oxide is then reduced according to the same reactions.

A third technique consists of using reducing additives such as carbides, nitrides, silicides, borides or carbon in mineral or organic form, which is thrown into the contents of the crucible, further in order to produce reduction of ruthenium oxide.

A fourth main technique consists of raising the elaboration temperature in order to displace the redox equilibria towards the reducing side. Ruthenium oxide is then reduced according to a reaction RuO₂→Ru+O₂.

As an example, a confinement borosilicate glass comprising 17.5% of oxides of fission products according to the composition given in Table 2 was elaborated with a glass sinter comprising about 9.1% of iron oxide in majority in the oxidization state Fe₂ (FeO) according to the composition given in Table 3. The obtained glass was in the reduced state. The oxygen pressure was equal to 0.0016 bar at 1,100° C. Examination with a scanning electron microscope of the microstructure of the solidified glass shows that almost the totality of ruthenium was there in metal form. The electric resistivity of liquid glass was found to be equal to 10 Ohm.cm at 1,100° C., i.e. identical with that of the same glass without ruthenium.

This method is obviously applicable to other glass compositions.

TABLE 1
A GLASS OF THE R7T7 TYPE

| Oxides | % of oxide by mass |
|---|---|
| SiO₂ | 45.64 |
| B₂O₃ | 14.08 |
| Na₂O | 9.22 |
| Al₂O₃ | 4.30 |
| MgO | 0.03 |
| CaO | 4.06 |
| Li₂O | 1.99 |
| Fe₂O₃ | 0.60 |
| NiO | 0.79 |
| Cr₂O₃ | 0.09 |
| ZnO | 2.51 |
| P₂O₅ | 0.23 |
| SrO | 0.40 |
| ZrO₂ | 2.47 |
| MoO₃ | 2.20 |
| MnO₂ | 0.57 |
| CoO | 0.22 |
| CS₂O | 1.43 |
| BaO | 0.90 |
| La₂O₃ | 2.46 |
| Ce₂O₃ | 1.27 |
| Nd₂O₃ | 2.13 |
| Pr₂O₃ | 0.70 |
| SnO₂ | 0.07 |
| TeO₂ | 0.24 |
| RuO₂ | 1.40 |
| Total | 100.00 |

TABLE 2
REDUCED GLASS

| Oxides | % of oxide by mass |
|---|---|
| SiO₂ | 41.51 |
| B₂O₃ | 12.80 |
| Na₂O | 8.72 |
| Al₂O₃ | 4.00 |
| MgO | 0.03 |
| CaO | 3.69 |
| Li₂O | 1.81 |
| FeO—Fe₂O₃ | 7.66 |
| NiO | 0.79 |
| Cr₂O₃ | 0.09 |
| ZnO | 2.29 |
| P₂O₅ | 0.23 |
| SrO | 0.40 |
| ZrO₂ | 2.42 |
| MoO₃ | 2.20 |
| MnO₂ | 0.57 |
| CoO | 0.22 |
| CS₂O | 1.43 |
| BaO | 0.90 |
| La₂O₃ | 2.45 |
| Ce₂O₃ | 1.27 |
| Nd₂O₃ | 2.12 |
| Pr₂O₃ | 0.70 |
| SnO₂ | 0.07 |
| TeO₂ | 0.24 |
| Ru—RuO₂ | 1.39 |
| Total | 100.00 |

TABLE 3
REDUCED SINTER

| Oxides | % of oxide by mass |
|---|---|
| SiO₂ | 53.50 |
| B₂O₃ | 16.50 |
| Na₂O | 6.40 |
| Al₂O₃ | 3.90 |
| CaO | 4.80 |
| Li₂O | 2.30 |
| FeO | 9.10 |
| ZnO | 2.90 |
| ZrO₂ | 0.60 |
| Total | 100.00 |

1-8. (canceled)

9. A method for vitrification of fission products in a confinement molten glass matrix, characterized in that the glass is elaborated in a chemically sufficiently reduced form in order to cause reduction of ruthenium oxides to metal ruthenium during said elaboration.

10. The vitrification method for fission products according to claim 9, characterized in that the glass is elaborated by using a reducing glass sinter, comprising at least one metal element present at an intermediate oxidation level between a metal state and a higher oxidation level.

11. The vitrification method for fission products according to claim 9, characterized in that the glass is elaborated by using glass precursors, comprising at least one metal element present at an oxidation level intermediate between a metal state and a higher oxidation level.

12. The vitrification method for fission products according to claim 10, characterized in that the metal element is selected from iron, cerium, chromium, vanadium, titanium, antimony and arsenic.

13. The vitrification method for fission products according to claim 11, characterized in that the metal element is selected from iron, cerium, chromium, vanadium, titanium, antimony and arsenic.

14. The vitrification method for fission products according to claim 9, characterized in that the glass is elaborated by using reducing additives.

15. The vitrification method for fission products according to claim 14, characterized in that the additives are selected from carbides, nitrides, silicides, borides or carbonaceous products.

16. The vitrification method for fission products according to claim 9, characterized in that the glass is elaborated by selecting a temperature producing decomposition of ruthenium oxides.
